(19) United States
(12) Patent Application Publication
(10) Pub. No.: US 2004/0139149 A1
(43) Pub. Date: Jul. 15, 2004

(54) Network data acquisition system

(76) Inventors: Daniel De Sousa, Qta. Sharon Caracas (VE); Gustavo Guerrero, Caracas (VE)

Correspondence Address: BACHMAN & LAPOINTE, P.C., 900 CHAPEL STREET, SUITE 1201, NEW HAVEN, CT, 06510, US

(21) Appl. No.: 10/691,795

(22) Filed: Oct. 23, 2003

Related U.S. Application Data
(60) Provisional application No. 60/439,593, filed on Jan. 13, 2003.

(51) Int. Cl. G06F 15/16

(52) U.S. Cl. 709/200

(57) ABSTRACT

A system is disclosed which provides for local gathering and translation of information from a wide variety of sources of such information, wherein the translation presents the information in a format which can be received by a wide variety of different applications and end users, and effectively utilized by same.

### CROSS REFERENCE TO RELATED APPLICATION

This application is a continuation-in-part of copending application Ser. No. 60/439,593, filed Jan. 13, 2003.

### BACKGROUND OF THE INVENTION

The invention relates to a network data acquisition system and, more particularly, to a system and method for communicating data from a plurality of potentially different industrial applications to a plurality of potentially different users of this data.

Conventional systems for acquiring data from various industrial installations communicate through a remote terminal unit (RTU) and a radio link to a master system which receives the information and distributes the information to various applications as necessary.

This conventional system is oriented to remote supervision of industrial processes such as, for example, monitoring of well-head surface variables.

This conventional approach provides for a relatively low count of variables which can be transmitted, a relatively low data transmission rate, a relatively low degree of integration to other corporate systems and the like, and allows for limited real-time data processing. Further, this architecture requires point-to-point direct communication between the field and a control room.

New concepts in oil well automation highlight deficiencies of conventional systems. For example, complex data structures such as dynagraphs, profiles, logs and the like are now frequently run at the well site.

Maintenance and other applications can also be downloaded to the well site to allow remote maintenance/downloading of various applications.

New sensors provide for large amounts of data such as profiles and logs, and also provide for protocol conversion at the oil well, for integration of specialized sensors-analyzers.

With these advances, far more data is available in the field than can be conveyed to up-stream applications and systems as may be desirable.

Based upon the foregoing, it is the primary object of the present invention to provide a system and method whereby communication of various types of data from the field to various different users of this information such as up-stream applications and corporate systems and the like is facilitated.

Other objects and advantages of the present invention will appear hereinbelow.

### SUMMARY OF THE INVENTION

In accordance with the present invention, the foregoing objects and advantages have been readily attained.

According to the invention, a system is provided which uses spread spectrum high speed radio links to allow for transmission of large amounts of data, such as profiles, buildup tests, logs and the like, and this data can be made directly available across TCP/IP networking, thereby using existing networking infrastructure to provide for communication of this data to users as desired.

In further accordance with the invention, a system is provided which comprises an installation-local unit comprising at least one receiver communicated with an installation for receiving real time data from said installation, and a formatting unit for formatting said real time data into a suitable communication protocol so as to provide universal data;

an additional unit spaced from said installation-local unit and communicated with said installation-local unit for receiving said universal data, and further comprising an additional formatting unit for translating said universal data into a different application protocol so as to provide user-application compatible data; and

a user-application of said real time data adapted to receive said user-application compatible data.

In accordance with another aspect of the present invention, translation of various types of data into an implemented communications protocol allows for a large degree of integration to various different types of corporate systems as desired.

Still further, a methol is provided for communicating remote sources and users of real time data which comprises time steps of providing an installation-local unit comprising at least one receiver communicated with an installation for receiving real time data from said installation and, a formatting unit for formatting said real time data into a suitable communication protocol so as to provide universal data;

providing an additional unit spaced from said installation-local unit and communicated with said installation-local unit for receiving said universal data, and further comprising an additional formatting unit for translating said universal data into a different application protocol so as to provide user-application compatible data;

transmitting said universal data from said installation-local unit to said additional unit;

translating said universal data into said user-application compatible data at said additional unit; and

providing said user-application compatible data to a user-application.

### BRIEF DESCRIPTION OF THE DRAWINGS

A detailed description of preferred embodiments of the present invention follows, with reference to the attached drawings, wherein:

FIG. 1 illustrates an architecture in accordance with the present invention.

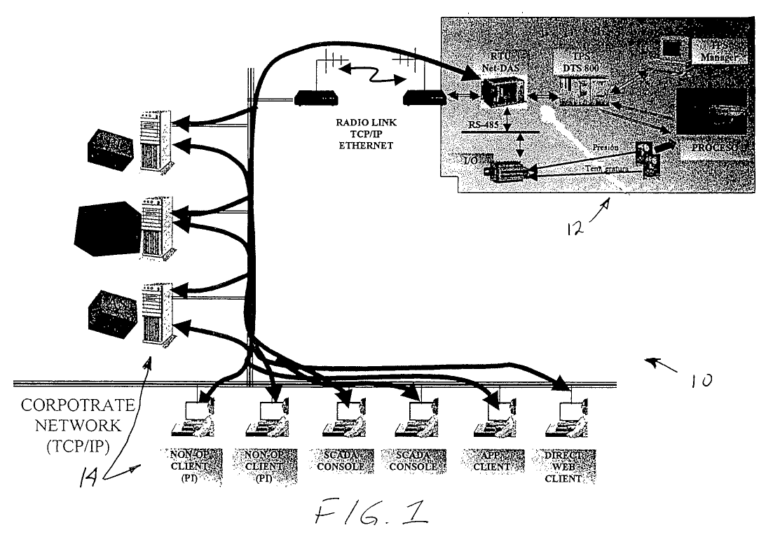

### DETAILED DESCRIPTION

The invention relates to a data acquisition and distribution system wherein various types of different data can be acquired from different sources such as different components of an oil field, collected at a remote terminal unit (RTU), translated into a format which allows for transmission of large amounts of data, and distributed via radio link, TCP/IP, Internet and the like to a wide variety of applications and/or users of the information as desired. The RTU is advantegeuosly an installation-local unit, that is, it is located at the site of a source of real time data.

The invention advantageously allows for communication of large volumes of data, which allow for remote and/or wireless access to real-time data related to complex relationships such as dynamometer charts, thermal profiles, video images and the like.

Furthermore, the invention advantageously allows for the bypass of a centralized receiving point for the data, such as a Supervisory Control and Data Acquisition (SCADA) terminal or the like, as is required in traditional architectures.

The system in accordance with the present invention utilizes high speed radio links to transmit data from the RTU to a communication network such as Internet, Ethernet, TCP/IP and the like. This high speed radio link, preferably spread spectrum high speed radio link, allows for transmission of several mb/s, and therefore allows for transmission of large amounts of data which can provide for substantially real-time access to profiles, buildup tests, logs and the like.

The data transmitted over the high speed radio links in accordance with the present invention is also advantageously translated or formatted into a suitable communication protocol which can be any widely supported and reliable communication protocol suite as would be available to a person of skill in the art, which allows for transfer of any data type, depending upon the application. Further, multiple communication protocols are possible utilizing the system of the present invention, as are multiple master systems such as SCADA and the like. Other, or additional, unit installations and the like to which the data is to be transmitted are likewise provided with formatting units, which can be in the form of RTUs or software modules, for translating from the suitable communication protocol to a format suitable to the application or user of the data.

Referring to the drawings, a system 10 is illustrated which communicates a plurality of sources of data in the field 12, or installation local units, with various different remote of spaced applications 14 as desired. In accordance with the invention, various different sources of data in field 12 can include a large variety of sources of information such as well temperatures, well pressures and the like which are conveyed from the process through an I/O and other communication equipment to the RTU in accordance with the present invention. A TPS manager is also communicated with the RTU through a TPS DTS 800, which can also be adapted to receive information from the various sources of such information at the process being monitored. This information at the RTU is translated into a suitable format which can advantageously be conveyed by radio link to a source or communication node at the Internet, or TCP/IP, or Ethernet, or the like, where this information can then be conveyed to the various different applications 14 as desired, and each application 14 is readily able to obtain the information needed and use same, regardless of the various different applications involved, and without the need for an intermediate data receiving and processing node, or SCADA, as is needed in conventional processes.

In accordance with the present invention, the RTU, or remote terminal unit, advantageously is adapted to acquire high volumes of variable data from industrial processes such as hydrocarbon producing wells in an oil field, and to locally process, format and then transmit over wireless and/or wire local area networks so as to provide the formatted various SCADA/information systems and/or for direct presentation, for example through a web browser.

The system in accordance with the present invention integrates commercial hardware, software and wireless communication systems and technologies to provide the desired function and, when installed in the field, acts as a platform for the system in accordance with the present invention.

The system advantageously provides for in-the-field advanced process control, advanced data acquisition, communication and integration and relational database management capabilities.

In further accordance with the present invention, software modules are provided which run in SCADA system/web pages, to interface and connect with the network and thereby retrieve data sent by the RTU in accordance with the present invention. This data can then be integrated and/or translated into the SCADA/web browser environment for storage and/or end user process supervision and control purposes. Thus, any processing system or workstation can be provided with software modules in order to receive, decode and utilize the various signals sent by the RTU in accordance with the present invention.

The system in accordance with the present invention advantageously allows remote maintenance of a system from any location accessible to the Internet and web browser capable.

The system of the present invention thereby advantageously enables remote supervision and control of any instrumented industrial installation, facility or equipment from any desktop computer located anywhere within either the corporate network, or accessible to the Internet, or the like, by taking advantage of existing corporate network infrastructure and personal desktop computers and software. Thus, the advantages of the present invention are provided without the need for investment in specialized systems and the like.

A further advantage of the present invention is the provision of a powerful, remotely-maintainable platform at the field level which is suitable for executing high level applications in the field. The system is particularly well suited for use in treating specialized high-volume data to various commercially available SCADA and information systems, which allows for remote display of complex data sets such as dynagraphs and the like.

In particular, the system of the present invention is particularly useful in the oil industry, and examples of suitable applications of the system of the present invention include real time acquisition, transmission and presentation of sucker-rod-pumping-unit oil well dynamonitor charts, thermal profiles extracted from commercially available thermal profile acquisition systems, predictive control algorithms for natural flow oil well down hole flowing pressure stabilization and control, and this is advantegeuosly based entirely upon real time data such as surface measurements, automated natural flow oil well build up test management and the like, with local on-wellhead-site storage of communication failure tolerance and transmission over the Internet of test results, and video supervision of oil industry facilities using existing networking infrastructure and web browsers to send video images along with process data to be displayed where needed.

It should readily be appreciated that the system in accordance with the present invention advantageously allows for advantageous distribution of real-time large volumes of data to users of such data at remote locations, substantially in real-time, whereby enhanced control and supervision of various different industrial processes, especially operation of wells in a hydrocarbon-producing oil field, can be accomplished.

Of course, the present disclosure is made in terms of a preferred embodiment of the present invention. Various different components can be utilized to provide the desired functionality, without departing from the broad scope of the present invention.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope.

What is claimed

1. A system for communicating remote sources and users of real time data, comprising:
an installation-local unit comprising at least one receiver communicated with an installation for receiving real time data from said installation and, a formatting unit for formatting said real time data into a suitable communication protocol so as to provide universal data;
an additional unit spaced from said installation-local unit and communicated with said installation-local unit for receiving said universal data, and further comprising an additional formatting unit for translating said universal data into a different application protocol so as to provide user-application compatible data; and
a user-application of said real time data adapted to receive said user-application compatible data.

2. The system of claim 1, wherein said installation-local unit and said additional unit are communicated by spread spectrum high speed radio link.

3. The system of claim 1, wherein said installation local unit comprises a plurality of installation local unit at least two of which generate said real time data in difficult formats, and wherein said additional unit comprises at least two additional unit having user-application of said real time data which require said real time data in at least two different formats.

4. The system of claim 1, wherein said installation-local unit further comprises a user of additional data from said additional unit, and wherein said additional formatting unit translates said additional data into said compatible communication protocol, and said formatting unit translate said suitable communication protocol suitable format for said user of additional data.

5. The system of claim 1, wherein said real time data is in a different format from said user-application compatible data.

6. The system of claim 1, wherein said additional unit is wireless communicated with said installation-local unit.

7. A method for communicating remote sources and users of real time data, comprising the steps of:
providing an installation-local unit comprising at least one receiver communicated with an installation for receiving real time data from said installation and, a formatting unit for formatting said real time data into a suitable communication protocol so as to provide universal data;
providing an additional unit spaced from said installation-local unit and communicated with said installation-local unit for receiving said universal data, and further comprising an additional formatting unit for translating said universal data into a different application protocol so as to provide user-application compatible data;
transmitting said universal data from said installation-local unit to said additional unit;
translating said universal data into said user-application compatible data at said additional unit; and
providing said user-application compatible data to a user-application.

8. The method of claim 7, wherein said installation-local unit and said additional unit are communicated by spread spectrum high speed radio link.

9. The method of claim 7, wherein said installation local unit comprises a plurality of installation local unit at least two of which generate said real time data in difficult formats, and wherein said additional unit comprises at least two additional unit having user-application of said real time data which require said real time data in at least two different formats.

10. The method of claim 7, wherein said installation-local unit further comprises a user of additional data from said additional unit, and wherein said additional formatting unit translates said additional data into said compatible communication protocol, and said formatting unit translate said suitable communication protocol suitable format for said user of additional data.

11. The method of claim 7, wherein said real time data is in a different format from said user-application compatible data.

12. The method of claim 7, wherein said additional unit is wireless communicated with said installation-local unit.
